(19) United States
(12) Patent Application Publication
(10) Pub. No.: US 2026/0217906 A1
(43) Pub. Date: Jul. 30, 2026

(54) POLYESTERS WITH LONG-CHAIN DICARBOXYLIC ACIDS

(71) Applicant: Novamont S.p.A., Novara (IT)

(72) Inventors: Catia BASTIOLI, Novara (IT); Luigi CAPUZZI, Novara (IT); Roberto VALLERO, Borgo D Ale (VC) (IT)

(73) Assignee: Novamont S.p.A., Novara (IT)

(21) Appl. No.: 19/141,549

(22) PCT Filed: Dec. 20, 2023
(86) PCT No.: PCT/EP2023/086983

§ 371 Date: Jun. 20, 2025

(30) Foreign Application Priority Data
Dec. 22, 2022 (IT) 102022000026589

(51) Int. Cl. C08G 63/52

(52) U.S. Cl. CPC C08G 63/52; C08G 2230/00

(57) ABSTRACT

The present invention relates to a diacid-diol polyester in which the dicarboxylic component comprises 1-60% in moles of units derived from 1,16-hexadecanedioic acid and 40-99% in moles of units derived from 1,18-octadecanedioic acid. This polyester, advantageously obtained from a renewable source, has thermal properties that make it suitable for use, as such or in mixtures with other polymers, in all the main transformation processes (e.g. film-forming, thermoforming, injection moulding, extrusion coating) and in particular for the preparation of thermoformed articles and films for food packaging.

This application relates to polyesters of long-chain dicarboxylic acids, polymer compositions and articles containing them; in particular, polyesters from diacid-diols comprising dicarboxylic acids with chains of 18 and 16 carbon atoms.

It is known that long-chain dicarboxylic acids (in the meaning of the present invention, those with 12 or more carbon atoms) have a wide range of applications as chemical intermediates in polymer production processes and in sectors as diverse as cosmetics, pharmaceuticals and detergents. For example, dodecanedioic acid (C12) is used for the synthesis of polyesters, polyamides and polyurethanes, which in turn find applications in fibres, films, resins, plasticisers, synthetic lubricants, coatings and adhesives. Their production by chemical means is however technically difficult, environmentally unsustainable and economically expensive. In recent years research has therefore turned its attention to the production of dicarboxylic acids by means of biotechnological processes mediated by microorganisms capable of using fatty acids or their derivatives as substrates, with the aim of achieving sustainable and low-cost processes by making use of raw materials of renewable origin.

However, renewable raw materials such as vegetable oils are characterised by the presence of mixtures of carboxylic acids having different chain lengths, and obtaining individual dicarboxylic acids requires complex purification operations.

In particular, there are still difficulties in obtaining dicarboxylic acids from the corresponding fermentation broths containing impurities, residual monoacids and unsaturations in particular, making them suitable for application as monomers in polymerisation. The presence of nitrogenous impurities from the fermentation production process may also impair the polymerisation process, for instance by affecting the performance of esterification catalysts.

Furthermore, it is well known that the composition of a polyester affects the characteristics of the end product, such as mechanical properties or biodegradability, and that the monomers used for the synthesis of polyesters must have sufficiently uniform thermal properties to ensure correct rheological behaviour during the conversion processes typically used for the production of end products.

All the drawbacks identified above have now been overcome by the polyesters according to the present invention.

In fact the invention relates to new diacid-diol polyesters in which the dicarboxylic component comprises mainly 1,18-octadecanedioic acid and 1,16-hexadecanedioic acid as co-monomers. This specific combination of co-monomers has been found to be particularly suitable for the production of diacid-diol polyesters, which have thermal properties and in particular a melting temperature and crystallisation temperature that make them suitable for use in all the main processes (e.g. film-forming, thermoforming, injection moulding, extrusion coating) and in particular in the preparation of thermoformed articles and films for food packaging.

A particularly advantageous aspect of the invention is that the polyester may be obtained from a wide range of renewable raw materials such as mixtures of fatty acids from vegetable oils.

The object of the present invention is thus a diacid-diol polyester in which the dicarboxylic component comprises:
i) 1-60% in moles, preferably 2-40% in moles, more preferably 5-15% in moles, of units derived from 1,16-hexadecanedioic acid or its C1-C24 alkyl esters;
ii) 40-99% in moles, preferably 60-98% in moles, more preferably 85-95% in moles, of units derived from 1,18-octadecanedioic acid or its C1-C24 alkyl esters.

While the presence of different co-monomers typically influences the properties of the co-polyesters obtained (e.g. leading to a decrease in temperature resistance), it was unexpectedly observed that co-polyesters containing octadecanedioic acid and hexadecanedioic acid as co-monomers exhibit substantially unchanged properties in comparison with the corresponding polyesters in which the aliphatic dicarboxylic component consists of octadecanedioic acid alone or hexadecanedioic acid alone, particularly when present in the quantities indicated above.

Consequently, such polyesters may be prepared from mixtures of these acids and do not require time-consuming steps for first obtaining high-purity dicarboxylic acids.

The dicarboxylic component of the polyesters according to the invention may indeed be advantageously obtained by suitable fermentation processes using vegetable oils, mixtures of monocarboxylic acids obtained therefrom or their derivatives, as starting material.

In particular, mixtures of monocarboxylic acids obtained from the hydrolysis of vegetable oils such as sunflower oil, thistle oil or palm oil are suitable. These typically comprise at least one saturated monocarboxylic acid with 18 carbon atoms, in an amount advantageously from 40 to 99% by weight, and at least one saturated C16 monocarboxylic acid, in an amount advantageously from 1 to 60% by weight, which may conveniently be converted into the corresponding dicarboxylic acids in a mixture.

The polyester according to the invention will be described in more detail below.

The dicarboxylic polyester component according to the invention mainly comprises 1,18-octadecanedioic acid and 1,16-hexadecanedioic acid as co-monomer.

The expression “mainly comprises” means that the sum of 1,18-octadecanedioic acid and 1,16-hexadecanedioic acid constitutes more than 90% in moles, preferably more than 95%, more preferably more than 98%, even more preferably more than 99% in moles, of the dicarboxylic component.

In the polyester according to the invention, 1,16-hexadecanedioic acid is present in the dicarboxylic component preferably in amounts from 1% to 20% in moles, more preferably from 1 to 15% in moles, more preferably from 1 to 12% in moles, in relation to the sum of 1,16-hexadecanedioic acid and 1,18-octadecanedioic acid.

The diacid-diol polyester according to the invention is of the aliphatic type, i.e., its dicarboxylic component consists of units derived from aliphatic dicarboxylic acids or their C1-C24 alkyl esters and comprises, or preferably consists of
i) 1-60% in moles, preferably 2-40%, more preferably 5-15% in moles, of units derived from 1,16-hexadecanedioic acid or its C1-C24 alkyl esters;
ii) 40-99% in moles, preferably 60-98%, more preferably 85-95% in moles, of units derived from 1,18-octadecanedioic acid or its C1-C24 alkyl esters

Any aliphatic dicarboxylic acids in the dicarboxylic component other than 1,16-hexadecanedioic acid and 1,18-octadecanedioic acid are preferably selected from C₁-C₂₄, preferably C₄-C₂₂ dicarboxylic acids, their C₁-C₂₄, preferably C₁-C₄, alkyl esters, their salts and mixtures thereof. Preferably, the aliphatic dicarboxylic acids are saturated. They are advantageously selected from succinic acid, adipic acid, azelaic acid, sebacic acid, dodecanedioic acid, brassylic acid, tetradecanedioic acid, docosanedioic acid, their C₁-C₂₄ alkyl esters, their salts and mixtures thereof.

C₁₀-C₂₂ saturated aliphatic dicarboxylic acids are preferred, for example dodecanedioic acid, brassylic acid, tetradecanedioic acid or docosanedioic acid.

The polyester according to the invention comprises, or preferably consists of, dicarboxylic acids and diols from renewable sources.

One or more unsaturated aliphatic dicarboxylic acids may be present in quantities advantageously lower than 5 percent in relation to the moles of aliphatic dicarboxylic units. They are preferably selected from hexadecendioic acid, octadecendioic acid and mixtures thereof.

With regard to the diol component of the polyester according to the invention, it is preferably selected from saturated aliphatic diols. It preferably comprises one or more diols selected from 1,2-ethanediol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,4-cyclohexanedimethanol, neopentyl glycol, 2-methyl-1,3-propanediol, dianhydrosorbitol, dianhydromannitol, dianhydroiditol, cyclohexanediol, cyclohexanmethanediol, dialkylene glycols and polyalkylene glycols with molecular weights of 100-4000 such as polyethylene glycol, polypropylene glycol and mixtures thereof.

Preferably, the diol component comprises at least 50% in moles of one or more diols selected from 1,2-ethanediol, 1,3-propanediol and 1,4-butanediol. More preferably, the diol component comprises 1,4-butanediol and/or 1,2-ethanediol; even more preferably, the diol component comprises 1,4-butanediol or 1,2-ethanediol.

Unsaturated aliphatic diols may possibly be present (preferably in amounts from 0 to 5% in moles of the diol component), for example selected from cis 2-buten-1,4-diol, trans 2-buten-1,4-diol, 2-butyn-1,4-diol, cis 2-penten-1,5-diol, trans 2-penten-1,5-diol, 2-pentyn-1,5-diol, cis 2-hexen-1,6-diol, trans 2-hexen-1,6-diol, 2-hexyn-1,6-diol, cis 3-hexen-1,6-diol, trans 3-hexen-1,6-diol, 3-hexyn-1,6-diol.

In a preferred embodiment, the polyester according to the invention is poly(1,4-ethylene octadecanedioate-co-hexadecanedioate), in another preferred embodiment is poly(1,4-butylene octadecanedioate-co-hexadecanedioate).

The polyester according to the present invention may also advantageously comprise repeating units derived from at least one hydroxyacid in an amount of between 0 and 30%, preferably between 0 and 25%, more preferably between 1 and 15%, even more preferably less than 10% in moles with respect to the total moles of the dicarboxylic component. Examples of convenient hydroxyacids are glycolic acid, hydroxybutyric acid, hydroxycaproic acid, hydroxyvaleric acid, 7-hydroxyheptanoic acid, 8-hydroxycaproic acid, 9-hydroxynonanoic acid, lactic acid or lactide. The hydroxyacids may be inserted into the chain as such or as prepolymers/oligomers, or they may also be first reacted with diacids or diols.

Long molecules with two functional groups, including non-terminal functional groups, may also be added in quantities not exceeding 10% in moles in relation to the total moles of the dicarboxylic component. Examples are dimer acids, ricinoleic acid and acids with epoxy functional groups, and also polyoxyethylenes with molecular weights of between 200 and 10000.

Diamines, amino acids, and amino-alcohols may also be present in percentages of up to 30% in moles with respect to the total moles of the dicarboxylic component.

In the process of preparing the polyester according to the present invention, one or more polyfunctional molecules may also be advantageously added in amounts of up to 3%, preferably between 0.1 and 1% in moles in relation to the total moles of the dicarboxylic component, in order to obtain branched products. Examples of these molecules are glycerol, pentaerythritol, trimethylolpropane, citric acid, dipentaerythritol, monoanhydrosorbitol, monoanhydromannitol, sorbitol, mannitol, acid triglycerides, polyglycerols, etc.

The molecular weight Mn of said polyester is preferably ≥15000, more preferably ≥20000. As for the polydispersity index of the molecular weights, Mw/Mn, this is preferably between 1.5 and 10, more preferably between 1.6 and 5 and even more preferably between 1.8 and 4.

The molecular weights Mn and Mw may be measured by Gel Permeation Chromatography (GPC). The determination may be conducted with the chromatographic system held at 40° C., using a set of two columns in series (particle diameter 5 μm and 3 μm with mixed porosity), a refractive index detector, chloroform as eluent (flow rate 0.5 ml/min) and using polystyrene as the reference standard.

The Melt Flow Rate (MFR) of the polyester is preferably between 500 and 1 g/10 min, more preferably between 100 and 3 g/10 min, even more preferably between 15 and 3 g/10 min (measured at 190° C./2.16 kg according to ISO 1133-1 “Plastics—determination of the melt mass-flow rate (MFR) and melt volume flow rate (MVR) of thermoplastics—Part 1: Standard method”).

According to this application, rheological properties are measured on a dried sample, that is one having a water content of less than 300 ppm, for example by drying for 1 hour at 90° C. in a ventilated oven.

The terminal acid groups content of said aliphatic polyester is preferably less than 100 meq/kg, preferably less than 60 meq/kg and even more preferably less than 40 meq/kg.

The terminal acid groups content may be measured as follows: 1.5-3 g of the polyester is placed in a 100 ml conical flask together with 60 ml of chloroform. After complete dissolution of the polyester, 25 ml of 2-propanol is added and, immediately before analysis, 1 ml of deionised water. The resulting solution is titrated with a previously standardised solution of NaOH in ethanol. An appropriate indicator, such as a glass electrode for acid-base titrations in non-aqueous solvents, is used to determine the equivalence point of the titration. The content of terminal acid groups is calculated on the basis of the consumption of NaOH solution in ethanol according to the following equation:

$$Terminal acid groups content ( meq / kg polymer ) = \frac{[ ( V e q - Vb ) \cdot T ] \cdot 1000}{P}$$

in which:
Veq=ml of NaOH solution in ethanol at the equivalence point of the sample titration;
Vb=ml of NaOH solution in ethanol required to achieve pH=9.5 in the blank titration;
T=concentration of NaOH solution in ethanol expressed in moles/litre;
P=weight of sample in grams.

Preferably, this polyester has an inherent viscosity (measured with a Ubbelohde viscometer for solutions in CHCl₃ of concentration 0.2 g/dl at 25° C.) greater than 0.3 dl/g, preferably between 0.3 and 2 dl/g, more preferably between 0.4 and 1.4 dl/g.

Said polyester may be synthesised according to any of the processes known in the state of the art. In particular, it may advantageously be obtained by a polycondensation reaction.

Examples of synthesis or polymerisation processes that may advantageously be used for the preparation of polyesters are described in international patent application WO 2016/050963.

Preferably, the process of synthesis of the polyester according to the invention comprises the steps of:
(i) preparing an oligomer product through an esterification and/or transesterification reaction of a mixture comprising:
   a) a dicarboxylic component comprising
      i) 1-60% in moles, preferably 2-40%, more preferably 5-15% in moles, of units derived from 1,16-hexadecanedioic acid;
      ii) 40-99% in moles, preferably 60-98%, more preferably 85-95% in moles, of units deriving from 1,18-octadecanedioic acid;
   b) a diol component,
   c) a hydroxyacid component in an amount of 0% to 30% by weight, preferably 1 to 15% by weight, in relation to the total weight of said mixture,
(ii) polycondensation of the oligomer product obtained from step (i), and
(iii) granulation of the polyester obtained from step (ii).

The mixture fed to step (i) is prepared from a dicarboxylic acid composition comprising mainly 1,18-octadecanedioic acid and 1,16-hexadecanedioic acid as co-monomer.

Said composition advantageously has a saturated monocarboxylic acid content of less than 0.5% by weight, preferably less than 0.2%, more preferably less than 0.1% and even more preferably less than 0.05% by weight. Advantageously, said composition has a nitrogen content of less than 500 ppm, preferably less than 100 ppm and more preferably less than 50 ppm.

According to a preferred aspect, said mixture advantageously comprises saturated aliphatic dicarboxylic acids having an odd number of carbon atoms (namely for example C15, C17 and C19) in an amount of less than 450 ppm, more preferably less than 350 ppm and even more preferably from 1 ppm to 200 ppm. More preferably, the content of said saturated aliphatic dicarboxylic acids having an odd number of carbon atoms is individually less than 150 ppm.

Other aliphatic dicarboxylic acids and the diol component which may be present in the mixture are preferably selected from those described above as possible components of the polyester.

Advantageously, the process of synthesis may be conducted in the presence of a suitable catalyst. Examples of suitable catalysts include organometallic tin compounds, e.g. stannoic acid derivatives, Titanium compounds, for example ortho-butyltitanate, Aluminium compounds, for example Al-triisopropyl, Antimony and Zinc and Zirconium compounds and mixtures thereof.

The product obtained from synthesis is a polyester that may in turn be subjected to reactive extrusion for the preparation of biodegradable polymer compositions.

The polyester according to the present invention is biodegradable. Within the meaning of the present invention, a biodegradable polymer is understood to be a polymer that is biodegradable according to EN 13432.

According to a preferred embodiment, the polyester of the present invention is biodegradable under home composting conditions according to UNI 11355; according to this embodiment its diol component advantageously comprises, or preferably consists of, 1,4-butanediol.

Polyesters according to the invention are extremely suitable for use, alone or in mixtures with other polymers, in many practical applications for the manufacture of products such as films, fibres, non-wovens, foils, and moulded, thermoformed, blown, foamed and laminated articles including using the extrusion coating technique.

Polyesters of the diacid-diol type according to the invention are advantageously used in a mixture, for example obtained by means of reactive extrusion processes, with one or more biodegradable or non-biodegradable natural or synthetic polymers other than said polyester of the diacid-diol type. Said mixture is preferably biodegradable according to EN 13432.

In particular, the polyesters according to the present invention may be used in mixtures with biodegradable polyesters of the diacid-diol, hydroxyacid or polyester-ether type.

As for these biodegradable polyesters of the diacid-diol type, they may be either aliphatic or aliphatic-aromatic.

Biodegradable aliphatic diacid-diol polyesters comprise aliphatic diacids and aliphatic diols, while biodegradable aliphatic-aromatic polyesters have an aromatic part consisting mainly of polyfunctional aromatic acids and an aliphatic part consisting of aliphatic diacids and aliphatic diols.

Biodegradable aliphatic aromatic diacid-diol polyesters are preferably characterised by a polyfunctional aromatic acid content of between 30 and 90% in moles, preferably between 45 and 70% in moles in relation to the total moles of the acid component.

Preferably the polyfunctional aromatic acids are selected from dicarboxylic aromatic compounds of the phthalic acid type and their esters, preferably terephthalic acid, and heterocyclic dicarboxylic aromatic acids and their esters, preferably 2,5-furandicarboxylic acid. In a particularly preferred embodiment, these heterocyclic dicarboxylic aromatic compounds are obtained from raw materials of renewable origin, thereby contributing to the diminishing utilisation of non-renewable resources such as raw materials of fossil origin.

Particularly preferred are aliphatic-aromatic polyesters in which the polyfunctional aromatic acids comprise mixtures of phthalic acid-type dicarboxylic aromatic compounds and heterocyclic dicarboxylic aromatic compounds in which the heterocyclic dicarboxylic aromatic compounds preferably make up 1-99%, preferably 5-95%, more preferably 20-90% in moles in relation to total moles of polyfunctional aromatic acids.

The aliphatic diacids of the biodegradable aliphatic and aliphatic-aromatic polyesters include saturated dicarboxylic acids such as oxalic acid, malonic acid, succinic acid, glutaric acid, adipic acid, pimelic acid, suberic acid, azelaic acid, sebacic acid, undecanoic acid, dodecanoic acid and brassylic acid, their esters and mixtures thereof. Among these, adipic acid and dicarboxylic acids from renewable sources such as succinic acid, sebacic acid, azelaic acid, undecanoic acid, dodecanoic acid and brassylic acid and their mixtures are particularly preferred.

Examples of aliphatic diols in the aliphatic and aliphatic-aromatic biodegradable diacid-diol polyesters are: 1,2-ethanediol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,4-cyclohexanedimethanol, neopentylglycol, 2-methyl-1,3-propanediol, dianhydrosorbitol, dianhydromannitol, dianhydroiditol, cyclohexanediol, cyclohexanmethanediol and mixtures thereof. Of these, 1,4-butanediol, 1,3-propanediol and 1,2-ethanediol and their mixtures are particularly preferred.

Preferably, the mixtures of the polyesters according to the present invention with the biodegradable aliphatic and aliphatic-aromatic diacid-diol polyesters described above are characterised by a biodegradable polyesters content varying in the range from 1 to 99% w/w, more preferably between 5 and 95% w/w, with respect to the sum of the weights of the polyesters according to the present invention and the latter respectively.

It is also possible to mix the polyesters according to the invention with more than one biodegradable polyester of the diacid-diol type. Particularly preferred are both binary and ternary mixtures of the polyesters obtained by the process according to the present invention with said biodegradable diacid-diol polyesters.

Preferred biodegradable hydroxyacid polyesters include: poly L lactic acid, poly D lactic acid and poly D-L lactic acid stereo complex, poly-s-caprolactone, polyhydroxybutyrate, polyhydroxybutyrate-valerate, polyhydroxy butyrate-propanoate, polyhydroxybutyrate-hexanoate, polyhydroxybutyrate-decanoate, polyhydroxy butyrate-decanoate, polyhydroxybutyrate-octadecanoate, poly 3-hydroxybutyrate-4-hydroxybutyrate.

Preferably, the mixtures of polyesters according to the present invention with the biodegradable hydroxyacid polyesters described above are characterised by a content of said biodegradable hydroxyacid polyesters in the range from 1 to 99% w/w, more preferably in the range from 5 to 95% w/w with respect to the sum of the weights of the polyesters according to the present invention and the latter respectively.

The polyesters according to the present invention may also be used in a mixture with polymers of natural origin such as starch, cellulose, chitin, chitosan, alginates, proteins such as gluten, zein, casein, collagen, gelatin, natural gums, rosinic acid and its derivatives, lignins as such or purified, hydrolysed, basified, etc., or their derivatives. Starches and celluloses may be modified, and these include, for example, starch or cellulose esters with a degree of substitution between 0.2 and 2.5, hydroxypropylated starches, starches modified with fatty chains, and cellophane. Mixtures with starch are particularly preferred. The starch may also be used in both unstructured and gelatinised form or as a filler. The starch may be the continuous or dispersed phase, or it may be in co-continuous form. In the case of dispersed starch, the starch is preferably in sub-micron form and more preferably of mean diameter less than 0.5 μm.

Preferably, the mixtures of the polyesters according to the present invention with the polymers of natural origin described above are characterised by a content of said polymers of natural origin varying in the range from 1 to 99% by weight, more preferably from 5 to 95% by weight, and more preferably from 10 to 40% by weight with respect to the sum of the weights of the polyesters according to the present invention and the latter respectively.

The polyesters according to the present invention may also be used in mixtures with polyolefins, aromatic polyesters, polyester- and polyether-urethanes, polyurethanes, polyamides, polyamino acids, polyethers, polyureas, polycarbonates and mixtures thereof.

Of the polyolefins, those preferred are polyethylene, polypropylene, their copolymers, polyvinyl alcohol, polyethyl vinyl acetate and polyethylene vinyl alcohol.

Of the aromatic polyesters those preferred are PET, PBT, PTT, in particular with a renewable content>30% and polyalkylenefurandicarboxylates. Of the latter, those particularly preferred are poly(1,2-ethylene-2,5-furandicarboxylate), poly(1,3-propylene-2,5-furandicarboxylate), poly(1,4-butylene-2,5-furandicarboxylate) and their mixtures.

Examples of polyamides are polyamide 6 and 6.6, polyamide 9 and 9.9, polyamide 10 and 10.10, polyamide 11 and 11.11, polyamide 12 and 12.12 and their combinations of the 6/9, 6/10, 6/11, 6/12 type.

The polycarbonates may be polyethylene carbonates, polypropylene carbonates, polybutylene carbonates, their mixtures and copolymers.

The polyethers may be polyethylene glycols, polypropylene glycols, polybutylene glycols, their copolymers and their mixtures having molecular weights from 70000 to 500000.

Preferably, the mixtures of the polyesters according to the present invention with the polymers described above (polyolefins, aromatic polyesters, polyester- and polyether-urethanes, polyurethanes, polyamides, polyamino acids, polyethers, polyureas, polycarbonates and mixtures thereof) are characterised by a content of said polymers varying within the range of 0.5-99% w/w, more preferably between 5-50% w/w with respect to the sum of the weights of the polyesters according to the present invention and the latter respectively.

The mixtures comprising polyester according to the invention may optionally comprise 0-5% by weight, more preferably 0.05-4% by weight, even more preferably 0.1-3% by weight relative to the total mixture, of at least one crosslinking agent and/or chain extender.

Said crosslinking agent and/or chain extender improves stability to hydrolysis and is selected from di- and/or polyfunctional compounds bearing isocyanate, peroxide, carbodiimide, isocyanurate, oxazoline, epoxy, anhydride, divinylether groups and mixtures thereof. Preferably, the crosslinking agent and/or chain extender comprises at least one di- and/or polyfunctional compound bearing epoxide or carbodiimide groups.

Preferably, the crosslinking agent and/or chain extender comprises at least one di- and/or polyfunctional compound bearing isocyanate groups. More preferably, the crosslinking agent and/or chain extender comprises at least 25% by weight of one or more di- and/or polyfunctional compounds bearing isocyanate groups. Especially preferred are mixtures of di- and/or polyfunctional compounds bearing isocyanate groups with di- and/or polyfunctional compounds bearing epoxide groups, even more preferably comprising at least 75% by weight of di- and/or polyfunctional compounds bearing isocyanate groups.

Preferably, the di- and polyfunctional compounds bearing isocyanate groups are selected from p-phenylene diisocyanate, 2,4-toluene diisocyanate, 2,6-toluene diisocyanate, 4,4-diphenylmethane diisocyanate, 1,3-phenylene-4-chloro diisocyanate, 1,5-naphthalene diisocyanate, 4,4-diphenylene diisocyanate, 3,3′-dimethyl-4,4-diphenylmethane diisocyanate, 3-methyl-4,4′-diphenylmethane diisocyanate, diphenylether diisocyanate, 2,4-cyclohexane diisocyanate, 2,3-cyclohexane diisocyanate, 1-methyl-2,4-cyclohexyl diisocyanate, 1-methyl-2,6-cyclohexyl diisocyanate, bis-(isocyanate cyclohexyl) methane, 2,4,6-toluene triisocyanate, 2,4,4-diphenylether triisocyanate, polymethylene-polyphenyl-polyisocyanates, methylene diphenyl diisocyanate, triphenylmethane triisocyanate, 3,3′dithiolylene-4,4-diisocyanate, 4,4′-methylene bis(2-methyl-phenyl isocyanate), hexamethylene diisocyanate, 1,3-cyclohexylene diisocyanate, 1,2-cyclohexylene diisocyanate and mixtures thereof. In a preferred embodiment the compound bearing isocyanate groups is 4,4-diphenylmethane-diisocyanate.

With regard to the di- and polyfunctional compounds bearing peroxide groups, these are preferably selected from benzoyl peroxide, lauroyl peroxide, isononanoyl peroxide, di-(t-butylperoxyisopropyl)benzene, t-butyl peroxide, dicumyl peroxide, alpha, alpha′-di(t-butylperoxy) diisopropylbenzene, 2,5-dimethyl-2,5-di(t-butylperoxy) hexane, t-butyl cumyl peroxide, di-t-butyl peroxide, 2,5-dimethyl-2,5-di(t-butylperoxy) hex-3-yne, di(4-t-butylcyclohexyl) peroxy dicarbonate, dicetyl peroxydicarbonate, dimyristyl peroxydicarbonate, 3,6,9-triethyl-3,6,9-trimethyl-1,4,7-triperoxonane, di(2-ethylhexyl) peroxydicarbonate and mixtures thereof. The di- and polyfunctional compounds bearing carbodiimide groups which are preferably used in the mixture according to the present invention are selected from poly(cyclooctylene carbodiimide), poly(1,4-dimethylcyclohexylene carbodiimide), poly(cyclohexylene carbodiimide), poly(ethylene carbodiimide), poly(butylene carbodiimide), poly(isobutylene carbodiimide), polynonylene carbodiimide), poly(dodecylene carbodiimide), poly(neopentylene carbodiimide), poly(1,4-dimethylene phenylene carbodiimide), poly(2,2′,6,6′, tetraisopropyldiphenylene carbodiimide) (Stabaxol® D), poly(2,4,6-triisolpropyl-1,3-phenylene carbodiimide) (Stabaxol® P-100), poly(2,6-diisopropyl-1,3-phenylene carbodiimide) (Stabaxol® P), poly(tolyl carbodiimide), poly(4,4′-diphenylmethane carbodiimide), poly(3,3′-dimethyl-4,4′-biphenylene carbodiimide), poly(p-phenylene carbodiimide), poly(m-phenylene carbodiimide), poly(3,3′-dimethyl-4,4′-diphenylmethane carbodiimide), poly(naphthylene carbodiimide), poly(isophorone carbodiimide), poly(cumene carbodiimide), p-phenylene bis(ethylcarbodiimide), 1,6-hexamethylene bis(ethylcarbodiimide), 1,8-octamethylene bis(ethylcarbodiimide), 1,10-decamethylene bis(ethylcarbodiimide), 1,12-dodecamethylene bis(ethylcarbodiimide) and mixtures thereof.

Examples of di- and polyfunctional compounds bearing epoxide groups which may advantageously be used in the mixture according to the present invention are all polyepoxides from epoxidised oils and/or styrene-glycidyl ether-methyl methacrylate, glycidyl ether-methyl methacrylate in a molecular weight range between 1000 and 10000 and with a number of epoxides per molecule in the range from 1 to 30 and preferably between 5 and 25, and epoxides selected from the group comprising diethylene glycol diglycidyl ether, polyethylene glycol diglycidyl ether, polyglycerol polyglycidyl ether, 1,2-epoxybutane, polyglycerol polyglycidyl ether, isoprene diepoxide, and cycloaliphatic diepoxides, 1,4-cyclohexanedimethanol diglycidyl ether, glycidyl 2-methylphenyl ether, glycerol propoxylatotriglycidyl ether, 1,4-butanediol diglycidyl ether, sorbitol polyglycidyl ether, glycerol diglycidyl ether, the tetraglycidyl ether of meta-xylenediamine and the diglycidyl ether of bisphenol A and mixtures thereof.

In a particularly preferred embodiment of the invention, the crosslinking agent and/or chain extender optionally present in the invention comprises compounds bearing isocyanate groups, preferably 4,4-diphenylmethane-diisocyanate, and/or bearing carbodiimide groups, and/or bearing epoxy groups, preferably of the styrene-glycidyl ether-methylmethacrylate type.

In a particularly preferred embodiment of the invention, the crosslinking agent and/or chain extender comprises compounds bearing epoxy groups of the styrene-glycidyl ether-methyl methacrylate type.

Along with the di- and polyfunctional compounds bearing isocyanate, peroxide, carbodiimide, isocyanurate, oxazoline, epoxy, anhydride or divinylether groups, catalysts may also be used to increase the reactivity of the reactive groups. In the case of polyepoxides, fatty acid salts are preferably used, even more preferably calcium and zinc stearates.

Mixtures comprising polyester according to the invention may also optionally contain inorganic fillers.

Examples of suitable inorganic fillers are preferably selected from the group consisting of kaolin, barytes, clay, talc, calcium and magnesium, iron and lead carbonates, aluminium hydroxide, kieselguhr, aluminium sulphate, barium sulphate, silica, mica, titanium dioxide and wollastonite. Preferably the inorganic filler is present in an amount between 0 and 50% w/w, preferably between 5 and 40% w/w, more preferably between 10 and 30% w/w in relation to the total composition of the body (i). In a preferred embodiment of the present invention, the inorganic filler is talc.

The mixtures comprising polyester according to the present invention further optionally contain one or more additives selected from the group consisting of plasticisers, UV stabilisers, lubricants, nucleating agents, surfactants, antistatic agents, pigments, compatibilising agents, lignin, organic acids, antioxidants, anti-mould agents, waxes, process aids and polymer components preferably selected from the group consisting of vinyl polymers and diacid-diol polyesters other than the aliphatic and/or aliphatic/aromatic polyesters described above.

Each additive is present in quantities preferably less than 10% by weight, more preferably less than 5% by weight, even more preferably less than 1% by weight of the total weight of the mixture.

Slip and/or releasing agents include, for example, biodegradable fatty acid amides such as oleamide, erucamide, ethylene-bis-stearylamide, fatty acid esters such as glycerol oleates or glycerol stearates, saponified fatty acids such as stearates, inorganic agents such as silicas or talc. Of the slip and/or releasing agents, silicas are preferred.

The polyester according to the invention advantageously has water vapour permeability values which make it suitable for imparting a barrier effect. For example, it advantageously has WVTR (Water Vapour Transmission Rate) values of less than 200 g/m²/24 h, preferably less than 150 g/m²/24 h and more preferably less than 100 g/m²/24 h, measured at 23° C. and 85% RH according to ASTM F1249 on a 20 mm thick film.

The polyester according to the invention is therefore advantageously used in the preparation of thermoformed articles and films for packaging, obtained for example by blown, cast or extrusion coating/extrusion lamination, particularly for food packaging.

In a further aspect, the present invention relates to a product or article comprising at least one polyester according to the invention or a mixture according to the invention. Said product is suitable for a variety of applications. Examples of products comprising at least one polyester according to the present invention include the following:
films, optionally mono- or bi-layer, either single- or multi-layer with other polymer materials, with application for example as stretch film for foodstuffs, for baling in agriculture and for wrapping waste, or as mulching film in agriculture;
bags and liners for organic collection such as food waste and grass cuttings;
thermoformed items, both single and multilayer, also suitable for contact with food such as plates, cups, rigid containers, beverage capsules, lids, food packaging such as milk, yoghurt, meat and beverage containers, food containers that may be heated in conventional or microwave ovens;
coatings obtained using the extrusion coating technique;
multilayer laminates with layers of paper, plastics, aluminium, metallised films;
expanded or expandable granules for the production of formed parts by sintering;
expanded and semi-expanded products including expanded blocks made from pre-expanded particles;
expanded sheets, thermoformed expanded sheets, containers made from them for food packaging;
containers in general for fruit and vegetables;
composites with gelatinised, de-structured and/or complexed starch, natural starch, flours, other fillers of natural, vegetable or inorganic origin, as fillers; and
fibres, microfibres, composite fibres, fibres with different cross-sections, from round to multi-lobed, staple fibres, woven and non-woven or spunbonded or thermo-bonded fabrics for health, hygiene, agriculture and clothing.

The process according to the invention will now be described according to a non-limiting example.

### EXAMPLE

The following were loaded into a steel reactor having a geometric volume of 25 litres and equipped with mechanical stirring, a distillation column and a high-boiling agent abatement system connected to a vacuum system: 7190 g of octadecanedioic acid having the 1,16-hexadecanedioic acid content specified in Table 1, 2130 g of ethylene glycol and 4.2 g of glycerine.

The reactor was kept stirred under a flow of nitrogen to homogenise the mass, then 1.6 g of Tyzor TE (17 ppm titanium) was added and the temperature was gradually raised to 230° C. The esterification reaction was continued while maintaining the melt at 230° C. until conversion was above 85%, then a gradual vacuum was applied, reducing the pressure to 100 mbar over the course of 30 minutes.

At the end of the esterification phase, the vacuum was neutralised with nitrogen and 10.2 g of Tyzor TnBT (183 ppm Ti) was added; the pressure in the reactor was reduced to below 2 mbar over the course of 20 minutes while the temperature was increased to 245° C. The curing conditions were maintained for 2 hours, at the end of which the product was discharged and granulated.

The properties of the product, determined using the following methods, are shown in Table 1. The rheological data refer to a temperature of 150° C.

The inherent viscosity (ninh) was measured with an Ubbelohde viscometer in CHCl₃ (0.2 g/dl) at 25° C. according to ISO 1628-1.

The molecular weights Mn and Mw were measured by GPC, using a set of two columns in series (particle diameters of 5 μm and 3 μm with mixed porosity), a refractive index detector, chloroform as eluent (flow rate 0.5 ml/min) and using polystyrene as the reference standard.

The crystallisation temperature (Tc) was determined by DSC analysis according to ISO 11357 at a scan rate of 10° C./min.

The shear viscosity (ηt=0) was determined at 150° C. and the flow gradient γ=103.7 s″1 using a capillary with a diameter of 1 mm and L/D=30 according to ASTM D3835-90 “Standard Test Method for Determining Properties of Polymer Materials Using a Capillary Rheometer”; the thermal stability K (×10⁴) was determined at the same time.

The Melt Strength (MS) was measured according to ISO 16790:2005 at 150° C. and γ=103.7 s⁻¹ using a capillary of 1 mm diameter and L/D=30 at a constant acceleration of 6 mm/sec² and a stretching length of 110 mm; the resistance of the melt to elongation (Draw Ratio, DR) was determined at the same time.

The viscoelastic ratio RVE was determined as the ratio of shear viscosity to melt strength.

Table 2 shows the results of relative biodegradability tests in relation to cellulose, at 58° C., according to the method described below.

The following were added to IL hermetically sealed jars: 15 g of perlite hydrated with water (1:1 w/w), evenly distributed on the bottom; a thin intermediate layer of substrate consisting of 10 g of compost and 350 mg of test material; an upper layer consisting of a further 15 g of hydrated perlite (prepared as above in a crystalliser), evenly distributed. A beaker with 30 ml of 0.5N KOH was placed on top of the layers. At the same time, a technical control test was performed with the KOH solution and perlite (without compost). The KOH solution was replaced and titrated at regular intervals. For each sample, 3 ml of KOH solution was titrated with 0.3N HCl by a potentiometric method in order to measure the evolved CO₂ and obtain the biodegradation curves. The results were obtained as ml of acid consumed and moles/L of solution

TABLE 1
Polyester composition and properties

| | % | | | | Tc | ηt = 0 | K | MS | | |
|---|---|---|---|---|---|---|---|---|---|---|
| | C16 | ηinh | Mn | Mw | [° C.] | [Pa s]. | (×10\hat{ }4) | [cN] | DR | RVE |
| Comparative | 0.02 | 1.12 | 75914 | 150160 | 69 | 824 | 0.06 | 1.63 | 35 | 505 |
| Example 1 | | | | | | | | | | |
| Example 2 | 2.1 | 1.04 | 72120 | 169470 | 68 | 851 | 0.96 | 1.5 | 79 | 567 |

TABLE 2
Biodegradability

| | Thickness | Relative biodegradation at 58° C. |
|---|---|---|
| | (microns) | (no. of days) |
| Comparative | 30-40 | >90% (78 days) |
| Example 1 | | |
| Example 2 | 50-70 | >90% (50 days) |

1. A diacid-diol polyester in which the dicarboxylic component comprises:
i. 1-60% in moles of units derived from 1,16-hexadecanedioic acid; and
ii. 40-99% in moles of units derived from 1,18-octadecanedioic acid.

2. The diacid-diol polyester according to claim 1, comprising 1,16-hexadecanedioic acid in an amount from 1% to 20% in moles with respect to the sum of 1,16-hexadecanedioic acid and 1,18-octadecanedioic acid.

3. The diacid-diol polyester according to claim 1, in which the diol component comprises one or more diols selected from 1,2-ethanediol, 1,2-propanediol, 1,3-propanediol, 1,4-butanediol, 1,5-pentanediol, 1,6-hexanediol, 1,7-heptanediol, 1,8-octanediol, 1,9-nonanediol 1,10-decanediol, 1,11-undecanediol, 1,12-dodecanediol, 1,13-tridecanediol, 1,4-cyclohexanedimethanol, neopentylglycol, 2-methyl-1,3-propanediol, dianhydrosorbitol, dianhydromannitol, dianhydroiditol, cyclohexanediol, cyclohexanmethanediol, dialkylene glycols and polyalkylene glycols.

4. The diacid-diol polyester according to claim 3, wherein said diol component comprises at least 50% in moles of one or more diols selected from 1,2-ethanediol, 1,3-propanediol and 1,4-butanediol.

5. The diacid-diol polyester according to claim 1, which is biodegradable according to EN 13432.

6. The diacid-diol polyester according to claim 1, characterised by a water vapor permeability (WVTR) of less than 200 g/m²/24 h, measured on a 20 micrometre thick film at 23° C. and 85% RH according to ASTM F1249.

7. A mixture comprising the diacid-diol polyester according to claim 1 with one or more natural or synthetic polymers other than said diacid-diol polyester.

8. The mixture according to claim 7 wherein these polymers are selected from biodegradable diacid-diol type polyesters, hydroxyacid type polyesters and polyester-ether type polyesters.

9. The mixture according to claim 7 comprising starch.

10. An article Articles comprising at least one diacid-diol polyester according to claim 1 or mixtures thereof.

11. The diacid-diol polyester according to claim 2, in which the diol component comprises one or more diols selected from 1,2-ethanediol, 1,2-propanediol, 1,3-propanediol, 1,4-butanediol, 1,5-pentanediol, 1,6-hexanediol, 1,7-heptanediol, 1,8-octanediol, 1,9-nonanediol 1,10-decanediol, 1,11-undecanediol, 1,12-dodecanediol, 1,13-tridecanediol, 1,4-cyclohexanedimethanol, neopentylglycol, 2-methyl-1,3-propanediol, dianhydrosorbitol, dianhydromannitol, dianhydroiditol, cyclohexanediol, cyclohexanmethanediol, dialkylene glycols and polyalkylene glycols.

12. The diacid-diol polyester according to claim 11, wherein said diol component comprises at least 50% in moles of one or more diols selected from 1,2-ethanediol, 1,3-propanediol and 1,4-butanediol.

13. The diacid-diol polyester according to claim 2, which is biodegradable according to EN 13432.

14. The diacid-diol polyester according to claim 3, which is biodegradable according to EN 13432.

15. The diacid-diol polyester according to claim 4, which is biodegradable according to EN 13432.

16. The diacid-diol polyester according to claim 2, characterised by a water vapor permeability (WVTR) of less than 200 g/m²/24 h, measured on a 20 micrometre thick film at 23° C. and 85% RH according to ASTM F1249.

17. The diacid-diol polyester according to claim 3, characterised by a water vapor permeability (WVTR) of less than 200 g/m²/24 h, measured on a 20 micrometre thick film at 23° C. and 85% RH according to ASTM F1249.

18. The diacid-diol polyester according to claim 4, characterised by a water vapor permeability (WVTR) of less than 200 g/m²/24 h, measured on a 20 micrometre thick film at 23° C. and 85% RH according to ASTM F1249.

19. The diacid-diol polyester according to claim 5, characterised by a water vapor permeability (WVTR) of less than 200 g/m²/24 h, measured on a 20 micrometre thick film at 23° C. and 85% RH according to ASTM F1249.

20. A mixture comprising the diacid-diol polyester according to claim 2 with one or more natural or synthetic polymers other than said diacid-diol polyester.
